(19) United States
(12) Patent Application Publication
(10) Pub. No.: US 2025/0117969 A1
(43) Pub. Date: Apr. 10, 2025

(54) METHOD FOR VISUALIZING RENDERING PERFORMANCE, SERVER, AND COMPUTER READABLE STORAGE MEDIUM

(71) Applicant: HTC Corporation, Taoyuan City (TW)

(72) Inventor: Jung-Sen Yang, Taoyuan City (TW)

(73) Assignee: HTC Corporation, Taoyuan City (TW)

(21) Appl. No.: 18/605,845

(22) Filed: Mar. 15, 2024

Related U.S. Application Data
(60) Provisional application No. 63/542,500, filed on Oct. 4, 2023.

(51) Int. Cl. G06T 11/00; G06F 3/01; G06T 7/00

(52) U.S. Cl. CPC G06T 11/00; G06F 3/011; G06T 7/0002

(57) ABSTRACT

The embodiments of the disclosure provide a method for visualizing a rendering performance, a server, and a computer readable storage medium. The method includes: receiving a plurality of poses and a plurality of smoothness statuses respectively associated with the plurality of poses from a first client device; and outputting a rendering performance map based on the plurality of poses and the associated plurality of smoothness statuses, wherein the rendering performance map comprises a plurality of directional smoothness indicators.

### CROSS-REFERENCE TO RELATED APPLICATION

This application claims the priority benefit of U.S. provisional application Ser. No. 63/542,500, filed on Oct. 4, 2023. The entirety of the above-mentioned patent application is hereby incorporated by reference herein and made a part of this specification.

### BACKGROUND

### 1. Field of the Invention

The present disclosure generally relates to a mechanism for visualizing a performance, in particular, to a method for visualizing a rendering performance, a server, and a computer readable storage medium.

### 2. Description of Related Art

In the field of virtual reality (VR), the term of “remote rendering” refers to the process of offloading the rendering tasks of a VR experience from the local VR device (such as a VR head-mounted display (HMD) or a computer) to a remote server or a powerful computing resource. Instead of the VR device handling all the complex graphical computations required for a high-quality VR experience, these computations are performed on a remote rendering device, and only the resulting display information is sent back to the VR device.

The remote rendering mechanism provides a solution to allow low-end VR device to experience VR content by streaming from remote powerful graphics server, such as playing SteamVR content on a mobile VR device.

In general, the smoothness of the remote rendering is affected by two factors: (1) the wireless communication quality between the VR device and the remote rendering device; (2) the rendering process (e.g., rendering, decoding, encoding, etc.) performed on the VR device and/or the remote rendering device.

However, when the users are having unsmooth VR experience, the users may have doubts on the qualities of the VR device and/or the VR application, but the unsmooth VR experience may actually result from the user locating at a position having poor wireless communication quality and/or heavily loaded render processes.

### SUMMARY OF THE INVENTION

Accordingly, the disclosure is directed to a method for visualizing a rendering performance, a server, and a computer readable storage medium, which may be used to solve the above technical problems.

The embodiments of the disclosure provide a method for visualizing a rendering performance, including: receiving, by a server, a plurality of poses and a plurality of smoothness statuses respectively associated with the plurality of poses from a first client device; and outputting, by the server, a rendering performance map based on the plurality of poses and the associated plurality of smoothness statuses, wherein the rendering performance map comprises a plurality of directional smoothness indicators.

The embodiments of the disclosure provide a server including a storage circuit and a processor. The storage circuit stores a program code. The processor is coupled to the storage circuit and configured to access the program code to perform: receiving a plurality of poses and a plurality of smoothness statuses respectively associated with the plurality of poses from a first client device; and outputting a rendering performance map based on the plurality of poses and the associated plurality of smoothness statuses, wherein the rendering performance map comprises a plurality of directional smoothness indicators.

The embodiments of the disclosure provide a non-transitory computer readable storage medium, the computer readable storage medium recording an executable computer program, the executable computer program being loaded by a server to perform steps of: receiving a plurality of poses and a plurality of smoothness statuses respectively associated with the plurality of poses from a first client device; and outputting a rendering performance map based on the plurality of poses and the associated plurality of smoothness statuses, wherein the rendering performance map comprises a plurality of directional smoothness indicators.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the disclosure.

FIG. 1 shows a schematic diagram of a server and some client devices according to an embodiment of the disclosure.

FIG. 2 shows a flow chart of the method for visualizing a rendering performance according to an embodiment of the disclosure.

FIG. 3A and FIG. 3B show schematic diagram of rendering performance maps corresponding to the same reference field according to embodiments of the disclosure.

FIG. 4 shows a schematic diagram of an integrated rendering performance map after adjusting the spatial configuration of the reference field according to FIG. 3A and FIG. 3B.

FIG. 5 shows a schematic diagram of the MR visual content rendered by the first client device according to an embodiment of the disclosure.

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

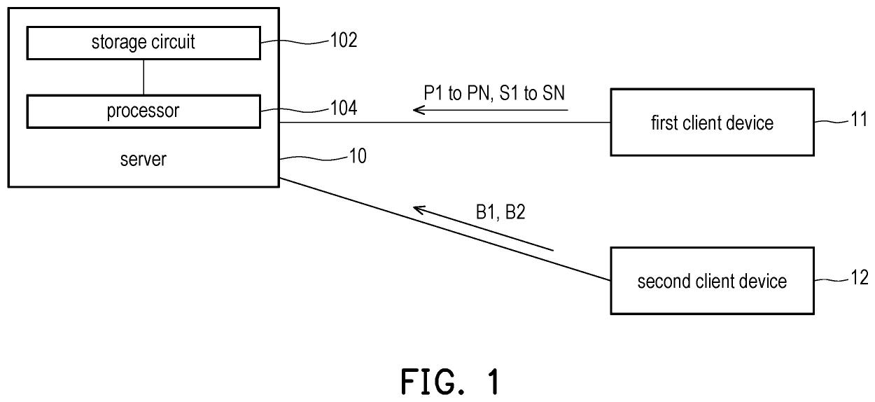

See FIG. 1, which shows a schematic diagram of a server and some client devices according to an embodiment of the disclosure. In FIG. 1, the server 10 may be connected with the first client device 11 and the second client device 12. In various embodiments, the server 10, the first client device 11, and/or the second client device 12 may be any smart device/computer device. In some embodiments, the server 10 may be a center device that can process/analyse the data/information provided by the first client device 11 and/or the second client device 12.

In some embodiments, the first client device 11 and/or the second client device 12 may be the hosts providing the visual contents of reality services (e.g., the VR service, augmented reality (AR) service, mixed reality (MR) service, etc.), such as HMDs, but the disclosure is not limited thereto.

In the embodiments of the disclosure, the operations performed between the server 10 and the first client device 11 may be similar to the operations performed between the server 10 and the second client device 12. In this case, the following discussions would be mainly provided by introducing the operations performed between the server 10 and the first client device 11, and people having ordinary skills in the art should be able to accordingly derive how the operations between the server 10 and the second client device 12 are performed, but the disclosure is not limited thereto.

In some embodiments, the server 10 may be the remote rendering device of the first client device 11 and/or the second client device 12. In some other embodiments, the remote rendering device of the first client device 11 and/or the second client device 12 may be some devices other than the server 10.

For better understanding, the server 10 would be assumed to be the remote rendering device of the first client device 11 (and/or the second client device 12) in the following discussions, but the disclosure is not limited thereto. In this case, the first client device 11 (e.g., the HMD) may transmit the poses (e.g., 6 degree-of-freedom (DOF) data) of the first client device 11 to the server 10, and the server 10 may accordingly render the visual content (e.g., VR content) of the reality service application (e.g., the VR application) provided by the first client device 11.

In some embodiments, the first client device 11 may detect the pose thereof by using the built-in motion detection circuit (e.g., the inertia measurement unit (IMU)) and/or by performing tracking mechanisms (e.g., inside-out and/or outside-in), but the disclosure is not limited thereto.

In the embodiments of the disclosure, each pose may include the corresponding position and the corresponding orientation, but the disclosure is not limited thereto.

Once the server 10 finishes the rendering of the visual content, the server 10 may encode the rendered visual content into data streams and transmit the data streams to the first client device 11. Afterwards, the first client device 11 may decode the data streams into the visual content and display the visual content for the user to see.

However, if the wireless communication quality between the server 10 and the first client device 11 is poor, the pose of the first client device 11 may not be properly/efficiently transmitted to the server 10. Likewise, the server 10 may not properly/efficiently transmit the data stream corresponding to the rendered visual content to the first client device 11. In either case, the user may have an unsmooth experience while interacting with the reality service application.

In addition, if the pose of the first client device 11 indicates that the user is facing a relatively complicated virtual scene in the virtual environment of the reality service application, not only the server 10 may need more time to render and/or encoding the corresponding visual content, but the first client device 11 would also need more time to decode the associated data streams. In this case, the user would also have an unsmooth experience while interacting with the reality service application.

As can be known from the above, the unsmooth experience may result from the user being at positions/locations/regions having poor wireless communication quality and/or the user being at positions/locations/regions leading to heavily loaded render process.

From another perspective, if the user may avoid staying at those positions/locations/regions having poor wireless communication quality and/or leading to leading to heavily loaded render process, it would be more unlikely for the user to have an unsmooth experience while interacting with the reality service application.

Accordingly, the embodiments of the disclosure provide a solution to resolve the above technical problem, which would be introduced later in detail.

In FIG. 1, the storage circuit 102 is one or a combination of a stationary or mobile random access memory (RAM), read-only memory (ROM), flash memory, hard disk, or any other similar device, and which records a plurality of modules and/or a program code that can be executed by the processor 104.

The processor 104 may be coupled with the storage circuit 102, and the processor 104 may be, for example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like.

In some embodiments, the first client device 11 and/or the second client device 12 may have similar structure to the server 10, but the disclosure is not limited thereto.

In the embodiments of the disclosure, the processor 104 may access the modules and/or the program code stored in the storage circuit 102 to implement the method for visualizing a rendering performance provided in the disclosure, which would be further discussed in the following.

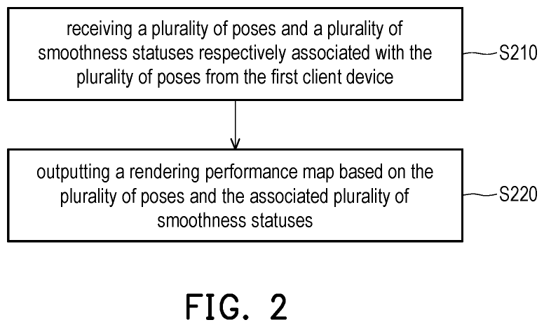

See FIG. 2, which shows a flow chart of the method for visualizing a rendering performance according to an embodiment of the disclosure. The method of this embodiment may be executed by the server 10 in FIG. 1, and the details of each step in FIG. 2 will be described below with the components shown in FIG. 1.

In step S210, the processor 104 receives a plurality of poses and a plurality of smoothness statuses respectively associated with the plurality of poses from the first client device 11.

In the embodiments of the disclosure, the user of the first client device 11 may move around in a reference field. In some embodiments, the reference field may be the play area where the user experiences the reality service application (e.g., the VR application). In this case, the user may see the virtual environment of the reality service application displayed by the first client device 11 while moving around, but the disclosure is not limited thereto.

In the duration where the first client device 11 moving around with the user in the reference field, the first client device 11 may detect the poses thereof at different timing points in the duration and the associated smoothness statuses.

In the embodiments of the disclosure, the plurality of poses may include a first pose, the plurality of smoothness statuses may include a first smoothness status associated with the first pose, and the first smoothness status is detected in a case where the first client device 11 is with the first pose.

For example, assuming that the duration where the first client device 11 moving around with the user in the reference field includes timing points T1 to TN (N is a positive integer), the first client device 11 may detect the pose and the associated smoothness status at each of the timing points T1 to TN.

For better understanding, the i-th timing point (i is an index from 1 to N) among the timing points T1 to TN may be referred to timing point Ti. In this case, the first client device 11 may detect the pose at the timing point Ti and the associated smoothness status, wherein the pose detected at the timing point Ti may be referred to as pose Pi, and the smoothness status associated with the pose Pi may be referred to as smoothness status Si, but the disclosure is not limited thereto.

In this case, the poses received by the server 10 may include poses P1 to PN, and the smoothness statuses received by the server 10 may include the smoothness statuses S1 to SN, but the disclosure is not limited thereto.

In the embodiments of the disclosure, the first smoothness status may include a first wireless communication quality of the first client device 11 communicating with the remote rendering device (e.g., the server 10) of the first client device 11.

In different embodiments, the first wireless communication quality of the first smoothness status may be characterized by, for example, the received signal strength indicator (RSSI), signal-to-noise ratio (SNR), signal to interference & noise ratio (SINR), data throughput, data drop rate, or the like, but the disclosure is not limited thereto.

For example, the smoothness status Si associated with the pose Pi may include the corresponding wireless communication quality, which may be characterized by, for example, the RSSI determined by the first client device 11 at the timing point Ti, but the disclosure is not limited thereto.

In some embodiments, the first smoothness status may further include a first render status of a rendering process performed on at least one of the first client device and the remote rendering device of the first client device.

In different embodiments, the first render status of the rendering process may include at least one of a rendering frame rate of the remote rendering device (e.g., the server 10), a rendering time of the remote rendering device, an encoding time of the remote rendering device, an encoding frame rate of the remote rendering device, a decoding rate of the first client device 11, a decoding time of the first client device 11, and a client rendering rate of the first client device 11, but the disclosure is not limited thereto.

For example, the smoothness status Si associated with the pose Pi may further include the corresponding render status, which may include one or more of the above factors (e.g., the rendering frame rate, the rendering time, etc.) detected at the timing point Ti, but the disclosure is not limited thereto.

In the embodiments where the remote rendering device is assumed to be the server 10, some of the above information may be determined/detected by the server 10 itself, such as the rendering frame rate, the rendering time, the encoding time, the encoding frame rate, but the disclosure is not limited thereto.

As mentioned in the above, the poses P1 to PN and the associated smoothness statuses S1 to SN may be detected by the first client device 11 in a case where the first client device 11 is displaying the virtual environment of the reality service application in the reference filed. In one embodiment, the corresponding relationship between the virtual environment and the reference field may be fixed.

That is, if the first client device 11 has the same pose at different timing points, the first client device 11 will display the same virtual scene of the virtual environment for the user to see. From another perspective, if there are two poses at two timing points that indicate the user is at the same position with the same orientation in the reference field at these two timing points, the user would see the same virtual scene at these two timing points.

More specifically, the virtual environment corresponding to the reference field would not be varied as time goes by, but the disclosure is not limited thereto.

In step S220, the processor 104 outputs a rendering performance map based on the plurality of poses P1 to PN and the associated plurality of smoothness statuses S1 to SN, wherein the rendering performance map includes a plurality of directional smoothness indicators.

In one embodiment, the plurality of the directional smoothness indicators may include a first directional smoothness indicator determined based on the first pose and the associated first smoothness status.

In one embodiment, the first pose may include a position and an orientation, the first directional smoothness indicator may include a first smoothness indicator and a first directional indicator. In addition, the first smoothness indicator corresponds to the first smoothness status, a first position of the first smoothness indicator in the rendering performance map corresponds to the position of the first pose, and the first directional indicator corresponds to the orientation of the first pose.

In one embodiment, a visual type of the first smoothness indicator is determined based on the first smoothness status, and a direction where the first directional indicator points is determined based on the orientation of the first pose.

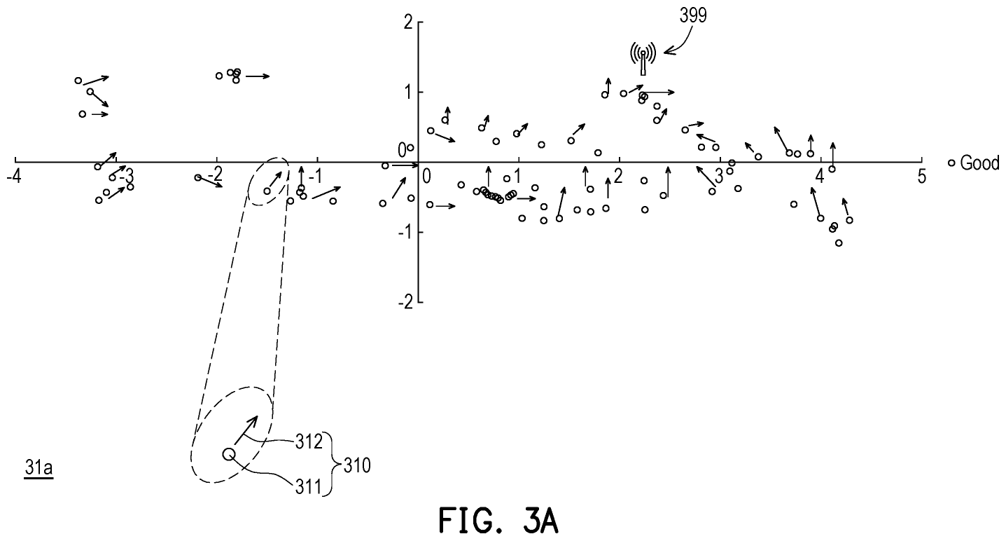

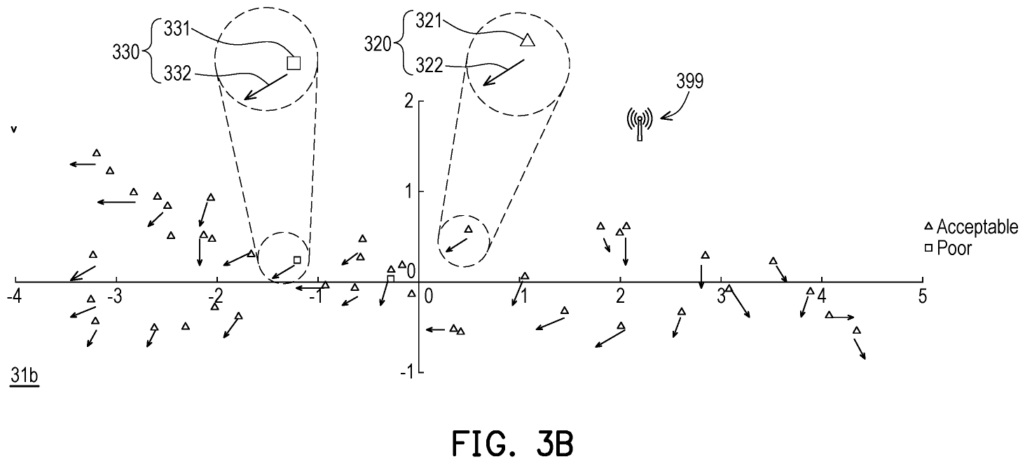

For better understanding, FIG. 3A and FIG. 3B would be used as examples, wherein FIG. 3A and FIG. 3B show schematic diagram of rendering performance maps corresponding to the same reference field according to embodiments of the disclosure.

In the embodiments of the disclosure, each rendering performance map mentioned in the above can be specifically knowns as a remote rendering performance map, which shows the performance of the remote rendering, but the disclosure is not limited thereto.

In the embodiments of the disclosure, the visual type of a particular smoothness indicator may be shown as a hollowed circle if the corresponding smoothness status is determined to be good (e.g., good wireless communication quality and good render status). In addition, the visual type of a particular smoothness indicator may be shown as a hollowed triangle if the corresponding smoothness status is determined to be acceptable (e.g., acceptable wireless communication quality and acceptable render status). Moreover, the visual type of a particular smoothness indicator may be shown as a hollowed square if the corresponding smoothness status is determined to be poor (e.g., poor wireless communication quality and poor render status), but the disclosure is not limited thereto.

Based on the above assumption, FIG. 3A can be understood as only showing the directional smoothness indicator corresponding to good smoothness status since all of the smoothness indicators shown in FIG. 3A are illustrated as hollowed circles. Likewise, FIG. 3B can be understood as only showing the directional smoothness indicator corresponding to acceptable/poor smoothness status since the smoothness indicators shown in FIG. 3B are illustrated as hollowed triangles or squares, but the disclosure is not limited thereto.

In FIG. 3A, the rendering performance map 31a may correspond to a top view of the reference field and includes several directional smoothness indicators, and each directional smoothness indicator may include a smoothness indicator (illustrated as a hollowed circle) and a directional indicator (illustrated as an arrow). That is, each directional smoothness indicator is shown as a combination of a hollowed circle and an arrow in FIG. 3A, but the disclosure is not limited thereto. In FIG. 3A, the directional indicator (e.g., the arrow) in some of the directional smoothness indicators can be regarded as being omitted for conciseness, but the disclosure is not limited thereto.

Since the rendering performance map 31a shows numerous directional smoothness indicators, the directional smoothness indicator 310 would be used as an example for discussion, and the features of other directional smoothness indicators should be derivable by people having ordinary skills in the art.

In FIG. 3A, the illustrated directional smoothness indicators may respectively correspond to a part of the poses P1 to PN (and the associated smoothness statuses S1 to SN). For better understanding, the directional smoothness indicator 310 may be assumed to be corresponding to the pose P1 and the associated smoothness status S1.

In this case, the directional smoothness indicator 310 may be determined based on the pose P1 and the associated smoothness status S1. Specifically, the directional smoothness indicator 310 may include a smoothness indicator 311 and a directional indicator 312, wherein the position of the smoothness indicator 311 in the rendering performance map 31a corresponds to the position of the pose P1, and the directional indicator 312 corresponds to the orientation of the pose P1.

That is, the position of the smoothness indicator 311 in the rendering performance map 31a is the position of the pose P1, and the direction where the directional indicator 312 points is determined based on the orientation of the pose P1.

In one embodiment, the smoothness indicator 311 corresponds to the smoothness status S1. In one embodiment, a visual type of the smoothness indicator 311 is determined based on the smoothness status S1. In FIG. 3A, it is assumed that the smoothness status S1 is good, which makes the smoothness indicator 311 illustrated as the visual type of a hollowed circle, but the disclosure is not limited thereto.

Therefore, based on directional smoothness indicator 310, it can be observed that a good smoothness status can be achieved as long as a client device is located at the position indicated by the smoothness indicator 311 and facing the direction pointed by the directional indicator 312.

In FIG. 3B, the rendering performance map 31b may also correspond to the top view of the reference field and includes several directional smoothness indicators, and each directional smoothness indicator may include a smoothness indicator (illustrated as a hollowed triangle/square) and a directional indicator (illustrated as an arrow). That is, each directional smoothness indicator is shown as a combination of a hollowed triangle and an arrow or a combination of a hollowed square and an arrow in FIG. 3B, but the disclosure is not limited thereto. In FIG. 3B, the directional indicator (e.g., the arrow) in some of the directional smoothness indicators can be regarded as being omitted for conciseness, but the disclosure is not limited thereto.

Since the rendering performance map 31b shows numerous directional smoothness indicators, the directional smoothness indicators 320 and 330 would be used as an example for discussion, and the features of other directional smoothness indicators should be derivable by people having ordinary skills in the art.

In FIG. 3B, the illustrated directional smoothness indicators may respectively correspond to another part of the poses P1 to PN (and the associated smoothness statuses S1 to SN). For better understanding, the directional smoothness indicator 320 may be assumed to be corresponding to the pose P2 and the associated smoothness status S2.

In this case, the directional smoothness indicator 320 may be determined based on the pose P2 and the associated smoothness status S2. Specifically, the directional smoothness indicator 320 may include a smoothness indicator 321 and a directional indicator 322, wherein the position of the smoothness indicator 321 in the rendering performance map 31b corresponds to the position of the pose P2, and the directional indicator 322 corresponds to the orientation of the pose P2.

That is, the position of the smoothness indicator 321 in the rendering performance map 31b is the position of the pose P2, and the direction where the directional indicator 322 points is determined based on the orientation of the pose P2.

In one embodiment, the smoothness indicator 321 corresponds to the smoothness status S2. In one embodiment, a visual type of the smoothness indicator 321 is determined based on the smoothness status S2. In FIG. 3B, it is assumed that the smoothness status S2 is acceptable, which makes the smoothness indicator 321 illustrated as the visual type of a hollowed triangle, but the disclosure is not limited thereto.

Therefore, based on directional smoothness indicator 320, it can be observed that a acceptable smoothness status can be achieved as long as a client device is located at the position indicated by the smoothness indicator 321 and facing the direction pointed by the directional indicator 322.

In addition, the directional smoothness indicator 330 may be assumed to be corresponding to the pose PN and the associated smoothness status SN.

In this case, the directional smoothness indicator 330 may be determined based on the pose PN and the associated smoothness status SN. Specifically, the directional smoothness indicator 330 may include a smoothness indicator 331 and a directional indicator 332, wherein the position of the smoothness indicator 331 in the rendering performance map 31b corresponds to the position of the pose PN, and the directional indicator 332 corresponds to the orientation of the pose PN.

That is, the position of the smoothness indicator 331 in the rendering performance map 31b is the position of the pose PN, and the direction where the directional indicator 332 points is determined based on the orientation of the pose PN.

In one embodiment, the smoothness indicator 331 corresponds to the smoothness status SN. In one embodiment, a visual type of the smoothness indicator 331 is determined based on the smoothness status SN. In FIG. 3B, it is assumed that the smoothness status SN is poor, which makes the smoothness indicator 331 illustrated as the visual type of a hollowed square, but the disclosure is not limited thereto.

Therefore, based on directional smoothness indicator 330, it can be observed that a poor smoothness status would be achieved as long as a client device is located at the position indicated by the smoothness indicator 331 and facing the direction pointed by the directional indicator 332.

In one embodiment, FIG. 3A and FIG. 3B can be combined into another rendering performance map (referred to as an integrated rendering performance map) than shows the directional smoothness indicators in FIG. 3A and FIG. 3B. That is, the integrated rendering performance map would show all of the directional smoothness indicators in FIG. 3A and FIG. 3B, but the disclosure is not limited thereto.

In one embodiment, the integrated rendering performance map can be designed with filter functions that allows the user to particularly see the directional smoothness indicators corresponding to good/acceptable/poor smoothness statuses. For example, if the user intends to only see the directional smoothness indicators corresponding to good smoothness statuses, the user may activate the filter function corresponding to good smoothness statuses, such that the user can see the rendering performance map 31a in FIG. 3A. For another example, if the user intends to only see the directional smoothness indicators corresponding to acceptable and poor smoothness statuses, the user may activate the filter function corresponding to acceptable and poor smoothness statuses, such that the user can see the rendering performance map 31b in FIG. 3B, but the disclosure is not limited thereto.

From another perspective, the rendering performance maps mentioned in the above can be understood as providing the information about which regions of the reference field allow the user to have smooth experience (e.g., the regions indicated by the directional smoothness indicators in FIG. 3A), and which regions of the reference filed may lead to unsmooth experience (e.g., the regions indicated by the directional smoothness indicators in FIG. 3B).

In this case, the processor 104 can display the rendering performance maps 31a, 31b, and/or the integrated rendering performance map, such that the people maintaining the reality service application (e.g., the developer/manager/staff) can prevent the user from having unsmooth experience via, for example, adjusting the spatial configuration of the reference field (e.g., removing obstacles, enhancing signal strengths, adding base stations 399, etc.) and/or simplifying the virtual scenes in the virtual environment.

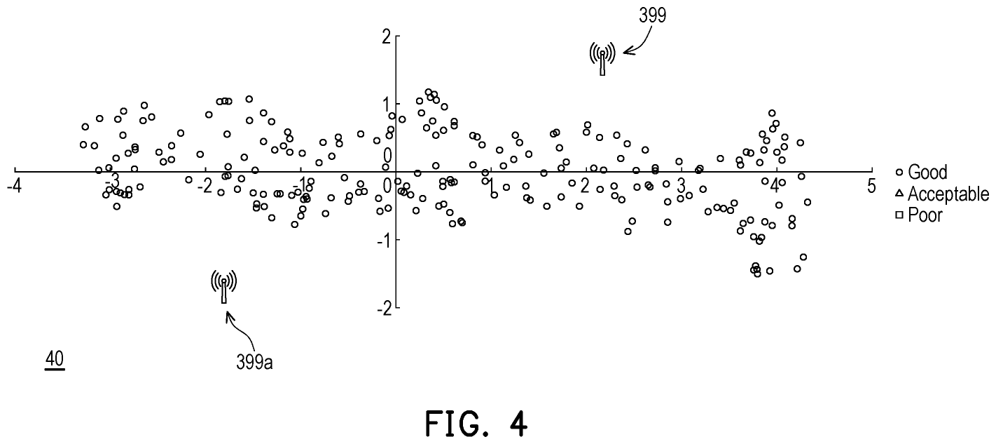

See FIG. 4, which shows a schematic diagram of an integrated rendering performance map after adjusting the spatial configuration of the reference field according to FIG. 3A and FIG. 3B. In FIG. 4, the directional indicator in each directional smoothness indicator can be regarded as being omitted for conciseness, but the disclosure is not limited thereto.

In FIG. 4, it is assumed that the spatial configuration of the reference field has been adjusted via disposing another base station 399a to the reference field, but the disclosure is not limited thereto.

As can be seen from FIG. 4, although the integrated rendering performance map 40 is controlled to show the directional smoothness indicators corresponding to good, acceptable, and poor smoothness statuses, it appears that all directional smoothness indicators in FIG. 4 correspond to good smoothness statuses. That is, it is less likely for the user to have unsmooth experience while interacting with the reality service application in the reference field corresponding to FIG. 4.

In addition, although only the operations between the server 10 and the first client device 11 are introduced in the above embodiments, the similar operations can also be performed between the server 10 and the second client device 12 (and/or even other client devices). For example, the processor 104 may receive a plurality of other poses B1 and a plurality of other smoothness statuses B2 respectively associated with the plurality of other poses B1 from the second client device 12, and the processor 104 may modify the rendering performance map based on the plurality of other poses B1 and the associated plurality of other smoothness statuses B2.

For example, the processor 104 may modify the rendering performance map 31a and/or 31b by adding other directional smoothness indicators determined based on the other poses B1 and the other smoothness statuses B2 from the second client device 12, but the disclosure is not limited thereto.

In some embodiments, the users can also be notified to, for example, avoid particular regions leading to unsmooth experience in the reference field. For example, the processor 104 may send one or more of the above rendering performance maps to the first client device 11.

In one embodiment, the first client device 11 can directly show the received rendering performance map(s) for the user to see, such that the user can accordingly adjust the user's position in the reference field.

In one embodiment, after receiving the rendering performance map from the server 10, the first client device 11 may render a mixed reality (MR) visual content based on a field of view (FOV) of the first client device 11 and the plurality of directional smoothness indicators in the rendering performance map. In one embodiment, the mixed reality (MR) visual content includes a plurality of virtual objects rendered based on the plurality of directional smoothness indicators.

In one embodiment, the first client device 11 (e.g., the HMD) may use its front camera having the FOV to capture images of the real world scene in front of the first client device 11 and accordingly render a pass-through view as a background of the MR visual content. In this case, the user can see the real world scene in front of the user in the MR visual content.

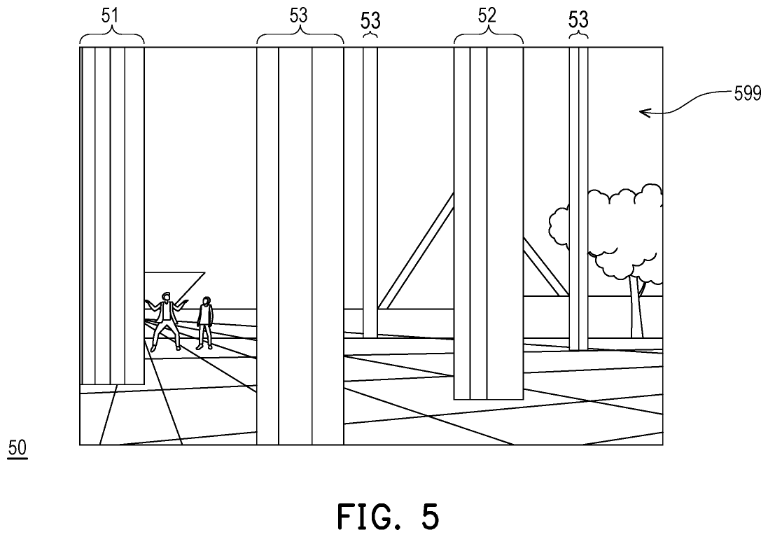

See FIG. 5, which shows a schematic diagram of the MR visual content rendered by the first client device according to an embodiment of the disclosure. In FIG. 5, the MR visual content 50 may include the pass-through view 599 and the virtual objects 51-53, wherein the pass-through view 599 may correspond to the real world scene in front of the user, and the virtual objects 51-53 may be rendered based on the directional smoothness indicators in the rendering performance map received by the first client device 11.

In the embodiment, for the directional smoothness indicators corresponding to good smoothness statuses, the first client device 11 may render, for example, a light beam with a first color (e.g., green) at the corresponding positions indicated by the directional smoothness indicators in the reference field.

In FIG. 5, it is assumed that the virtual objects 51 (e.g., the light beams with the first color) are rendered based on the directional smoothness indicators corresponding to good smoothness statuses. In this case, the user would know that the region indicated by the virtual object 51 may allow the user to have a smooth experience.

In the embodiment, for the directional smoothness indicators corresponding to acceptable smoothness statuses, the first client device 11 may render, for example, a light beam with a second color (e.g., blue) at the corresponding positions indicated by the directional smoothness indicators in the reference field.

In FIG. 5, it is assumed that the virtual objects 52 (e.g., the light beams with the second color) are rendered based on the directional smoothness indicators corresponding to acceptable smoothness statuses. In this case, the user would know that the region indicated by the virtual object 52 may lead to a less smooth experience.

In the embodiment, for the directional smoothness indicators corresponding to poor smoothness statuses, the first client device 11 may render, for example, a light beam with a third color (e.g., red) at the corresponding positions indicated by the directional smoothness indicators in the reference field.

In FIG. 5, it is assumed that the virtual objects 53 (e.g., the light beams with the third color) are rendered based on the directional smoothness indicators corresponding to poor smoothness statuses. In this case, the user would know that the region indicated by the virtual object 53 should be avoided to not have an unsmooth experience.

In some embodiments, the MR visual content 50 can also be rendered by the server 10 and provided to the first client device 11 for displaying, but the disclosure is not limited thereto.

The disclosure further provides a computer readable storage medium for executing the method for visualizing a rendering performance. The computer readable storage medium is composed of a plurality of program instructions (for example, a setting program instruction and a deployment program instruction) embodied therein. These program instructions can be loaded into the server 10 and executed by the same to execute the method for visualizing a rendering performance and the functions of the server 10 described above.

In summary, the embodiments of the disclosure provide a solution to integrate the poses and the associated smoothness statuses reported by the first client device into a rendering performance map with directional smoothness indicators that visualizing the poses and the associated smoothness statuses. In this case, the rendering performance map can show which regions of the reference field allow the remote rendering to be efficiently performed, and which regions of the reference field may decrease the efficiency of the remote rendering.

Accordingly, the rendering performance map may be used as a reference for improving the spatial configuration of the reference field, such the user experience can be improved.

In addition, the rendering performance map can be used to render the corresponding MR visual content, such that the directional smoothness indicators therein can be visualized as some particular regions in the real world scene for the user to see.

It will be apparent to those skilled in the art that various modifications and variations can be made to the structure of the present invention without departing from the scope or spirit of the disclosure. In view of the foregoing, it is intended that the present disclosure cover modifications and variations of this invention provided they fall within the scope of the following claims and their equivalents.

What is claimed is:

1. A method for visualizing a rendering performance, comprising:
receiving, by a server, a plurality of poses and a plurality of smoothness statuses respectively associated with the plurality of poses from a first client device; and
outputting, by the server, a rendering performance map based on the plurality of poses and the associated plurality of smoothness statuses, wherein the rendering performance map comprises a plurality of directional smoothness indicators.

2. The method according to claim 1, wherein the plurality of poses comprise a first pose, the plurality of smoothness statuses comprise a first smoothness status associated with the first pose, and the first smoothness status is detected in a case where the first client device is with the first pose.

3. The method according to claim 2, wherein the first smoothness status comprises a first wireless communication quality of the first client device communicating with a remote rendering device of the first client device.

4. The method according to claim 3, wherein the server is the remote rendering device of the first client device.

5. The method according to claim 3, wherein the first smoothness status further comprises a first render status of a rendering process performed on at least one of the first client device and the remote rendering device of the first client device.

6. The method according to claim 5, wherein the first render status of the rendering process comprises at least one of a rendering frame rate of the remote rendering device, a rendering time of the remote rendering device, an encoding time of the remote rendering device, an encoding frame rate of the remote rendering device, a decoding rate of the first client device, a decoding time of the first client device, and a client rendering rate of the first client device.

7. The method according to claim 1, wherein the plurality of poses and the associated plurality of smoothness statuses are detected by the first client device in a reference field.

8. The method according to claim 7, wherein the plurality of poses and the associated plurality of smoothness statuses are detected by the first client device in a case where the first client device is displaying a virtual environment of a reality service application in the reference filed, and a corresponding relationship between the virtual environment and the reference field is fixed.

9. The method according to claim 2, wherein the plurality of the directional smoothness indicators comprise a first directional smoothness indicator determined based on the first pose and the associated first smoothness status.

10. The method according to claim 9, wherein the first pose comprises a position and an orientation, the first directional smoothness indicator comprises a first smoothness indicator and a first directional indicator;
wherein the first smoothness indicator corresponds to the first smoothness status, a first position of the first smoothness indicator in the rendering performance map corresponds to the position of the first pose, and the first directional indicator corresponds to the orientation of the first pose.

11. The method according to claim 10, wherein a visual type of the first smoothness indicator is determined based on the first smoothness status, and a direction where the first directional indicator points is determined based on the orientation of the first pose.

12. The method according to claim 1, further comprising:
receiving, by the server, a plurality of other poses and a plurality of other smoothness statuses respectively associated with the plurality of other poses from a second client device; and
modifying, by the server, the rendering performance map based on the plurality of other poses and the associated plurality of other smoothness statuses.

13. The method according to claim 1, further comprising:
transmitting, by the server, the rendering performance map to the first client device.

14. The method according to claim 13, further comprising:
rendering, by the first client device, a mixed reality visual content based on a field of view of the first client device and the plurality of directional smoothness indicators in the rendering performance map, wherein the mixed reality visual content comprises a plurality of virtual objects rendered based on the plurality of directional smoothness indicators.

15. The method according to claim 1, wherein outputting the rendering performance map based on the plurality of poses and the associated plurality of smoothness statuses comprises:
displaying, by the server, the rendering performance map.

16. A server, comprising:
a non-transitory storage circuit, storing a program code; and
a processor, coupled to the non-transitory storage circuit and configured to access the program code to perform:
receiving a plurality of poses and a plurality of smoothness statuses respectively associated with the plurality of poses from a first client device; and
outputting a rendering performance map based on the plurality of poses and the associated plurality of smoothness statuses, wherein the rendering performance map comprises a plurality of directional smoothness indicators.

17. The server according to claim 16, wherein the plurality of poses comprise a first pose, the plurality of smoothness statuses comprise a first smoothness status associated with the first pose, and the first smoothness status is detected in a case where the first client device is with the first pose;
wherein the first smoothness status comprises a first wireless communication quality of the first client device communicating with a remote rendering device of the first client device;
wherein the first smoothness status further comprises a first render status of a rendering process performed on at least one of the first client device and the remote rendering device of the first client device.

18. The server according to claim 16, wherein the plurality of poses and the associated plurality of smoothness statuses are detected by the first client device in a reference field;
wherein the plurality of poses and the associated plurality of smoothness statuses are detected by the first client device in a case where the first client device is displaying a virtual environment of a reality service application in the reference filed, and a corresponding relationship between the virtual environment and the reference field is fixed.

19. The server according to claim 16, wherein the plurality of poses comprise a first pose, the plurality of smoothness statuses comprise a first smoothness status associated with the first pose, and the first smoothness status is detected in a case where the first client device is with the first pose;
wherein the plurality of the directional smoothness indicators comprise a first directional smoothness indicator determined based on the first pose and the associated first smoothness status.

20. A non-transitory computer readable storage medium, the computer readable storage medium recording an executable computer program, the executable computer program being loaded by a server to perform steps of:
receiving a plurality of poses and a plurality of smoothness statuses respectively associated with the plurality of poses from a first client device; and
outputting a rendering performance map based on the plurality of poses and the associated plurality of smoothness statuses, wherein the rendering performance map comprises a plurality of directional smoothness indicators.
